(19) United States
(12) Patent Application Publication
(10) Pub. No.: US 2026/0362120 A1
(43) Pub. Date: Nov. 12, 2026

(54) MECHANISMS FOR DATA COLLECTION CONTROL IN NETWORKS SUPPORTING AI/ML FUNCTIONALITY

(71) Applicant: InterDigital Patent Holdings, Inc., Wilmington, DE (US)

(72) Inventors: Jung Je Son, Warrington, PA (US); Ulises Olvera-Hernandez, Saint-Lazare (CA); Michel Roy, Candiac (CA); Guanzhou Wang, Brossard (CA); Samir Ferdi, Kirkland (CA)

(73) Assignee: InterDigital Patent Holdings, Inc., Wilmington, DE (US)

(21) Appl. No.: 19/202,856

(22) Filed: May 8, 2025

(51) Int. Cl. H04W 8/24; H04L 41/16

(52) U.S. Cl. CPC H04W 8/24; H04L 41/16

(57) ABSTRACT

Methods, apparatuses, and systems are disclosed. In one example, a method performed by a network device comprises receiving a first data collection request from a data consumer, wherein the first data collection request indicates at least one condition for WTRU selection for data collection for the data consumer; identifying a plurality of WTRUs that satisfy the at least one condition for WTRU selection based on WTRU capability information associated with the plurality of WTRUs; sending a plurality of second data collection requests to the plurality of WTRUs based on the first data collection request; receiving, from the plurality of WTRUs, data collected by the WTRUs responsive to the plurality of second data collection requests; curating the data collected by the WTRUs based on the first data collection request to form a curated set of collected data; and sending the curated set of collected data to the data consumer.

### BACKGROUND

In the 5G system, there is limited support for Artificial Intelligence and/or Machine Learning (AI/ML). However, next generation systems (e.g., 6G) may provide more support for AI/ML functionality to enhance cellular network performance as measured by various metrics.

### SUMMARY

Methods and apparatuses for operation by a Radio Access Network (RAN) node are provided.

In an example, a method performed by a network device may comprise receiving a first data collection request from a data consumer, wherein the first data collection request indicates at least one condition for wireless transmit/receive unit (WTRU) selection for data collection for the data consumer; identifying a plurality of WTRUs that satisfy the at least one condition for WTRU selection based on WTRU capability information associated with the plurality of WTRUs; sending a plurality of second data collection requests to the plurality of WTRUs based on the first data collection request; receiving, from the plurality of WTRUs, data collected by the WTRUs responsive to the plurality of second data collection requests; curating the data collected by the WTRUs based on the first data collection request to form a curated set of collected data; and sending the curated set of collected data to the data consumer.

The method may further comprise receiving the WTRU capability information from the plurality of WTRUs, wherein the WTRU capability information indicates, for each WTRU of the plurality of WTRUs: a list of features the WTRU supports; and/or an indication of one or more data formats the WTRU supports.

The first data collection request may comprise: an analytic ID that indicates an analytic service for which the data consumer requests data collection; an AI/ML model ID that indicates an AI/ML model to be trained via the data collected by the WTRUs;
a list of features for data collection, wherein the features are associated with the AI/ML model; or an indication of one or more requested formats of the features.

The at least one condition for WTRU selection may be based on one or more of: the list of features for data collection for the one or more requested formats of the features.

The at least one condition may be indicated by one or more parameters for data collection, and the method may further comprise negotiating the one or more the parameters for data collection with the data consumer based on the WTRU capability information.

The first data collection request may comprise a list of parameters for data collection, and the method may further comprise generating an updated list of features for data collection based on the negotiation of the one or more parameters for data collection, wherein each of the second data collection requests may comprise the updated list of features for data collection.

The first data collection request may indicate one or more statistical properties to be satisfied via the data collected by the WTRUs.

Curating the data collected by the WTRUs based on the first data collection request to form a curated set of collected data may comprise: deleting one or more outliers from the data collected by the WTRUs; removing redundant data from the data collected by the WTRUs; verifying that the data collected by the WTRUs satisfies the one or more statistical properties; and/or aligning a data format of the collected data with a data format indicated by the first data collection request.

The method may further comprise generating a list that indicates the plurality of WTRUs; determining, based on the data collected by the WTRUs, that at least one WTRU indicated by the list failed to satisfy the at least one condition for WTRU selection; and adjusting the list to remove the at least one WTRU therefrom.

The method may further comprise, prior to reception of the first data collection request: receiving a first data collection initiation request from a WTRU of the plurality of WTRUs; validating the first data collection initiation request based on one or more of: an operator policy, user privileges associated with the WTRU, and/or user consent associated with the WTRU); and sending a second data collection initiation request to the data consumer based on the validation of the first data collection initiation request.

The method may further comprise, prior to reception of the first data collection request: receiving a first data collection initiation request from a second RAN node; validating the first data collection initiation request; and sending a second data collection initiation request to the data consumer based on the validation of the first data collection initiation request.

The first data collection request may comprise an indication of a Data Network Access Identifier (DNAI) through which the data consumer (may be accessed.

The first data collection request may indicate a minimum distance of WTRUs, and wherein the at least one condition for WTRU selection is based on the minimum distance.

The method may further comprise, prior to sending the plurality of second data collection requests to the plurality of WTRUs based on the first data collection request, authorizing the first data collection request based on the WTRU capability information associated with the plurality of WTRUS.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 provides a diagram that depicts a process for WTRU data-collection control by a DCF, according to one example.

FIG. 3 provides a diagram that depicts another process for WTRU data-collection control by a DCF, according to one example.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

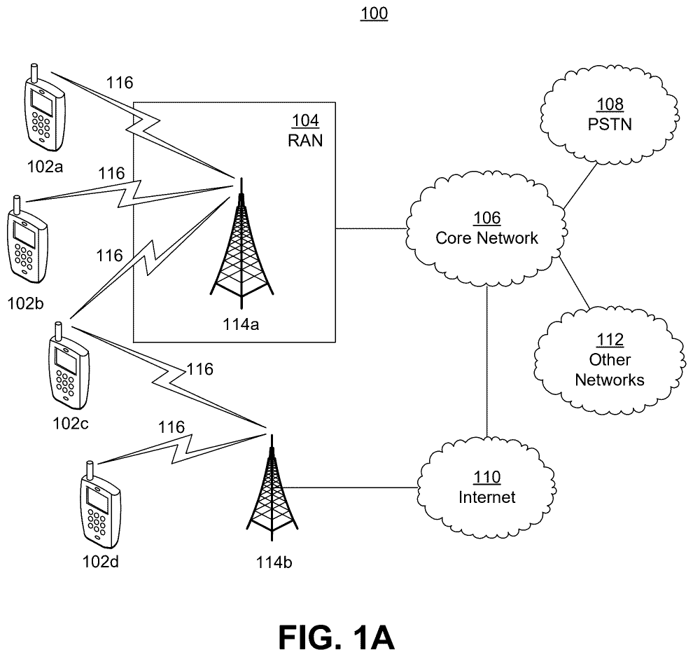

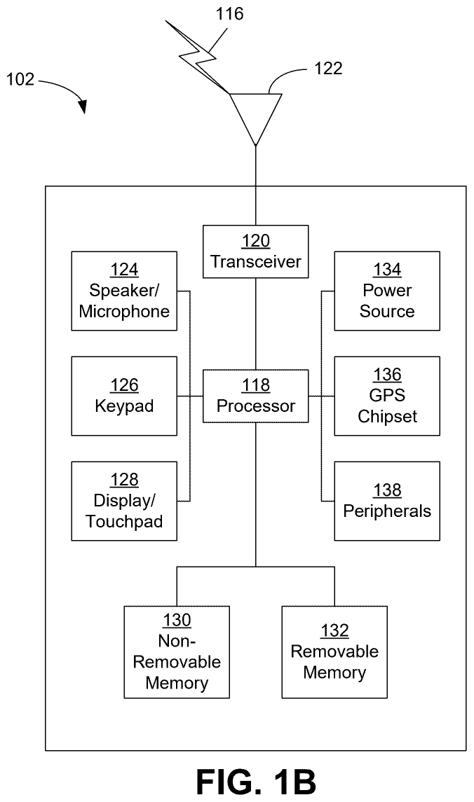

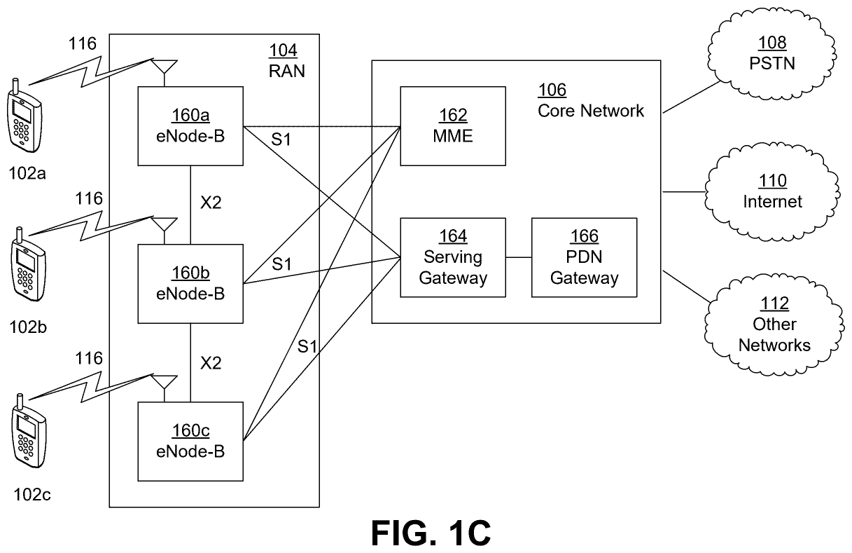

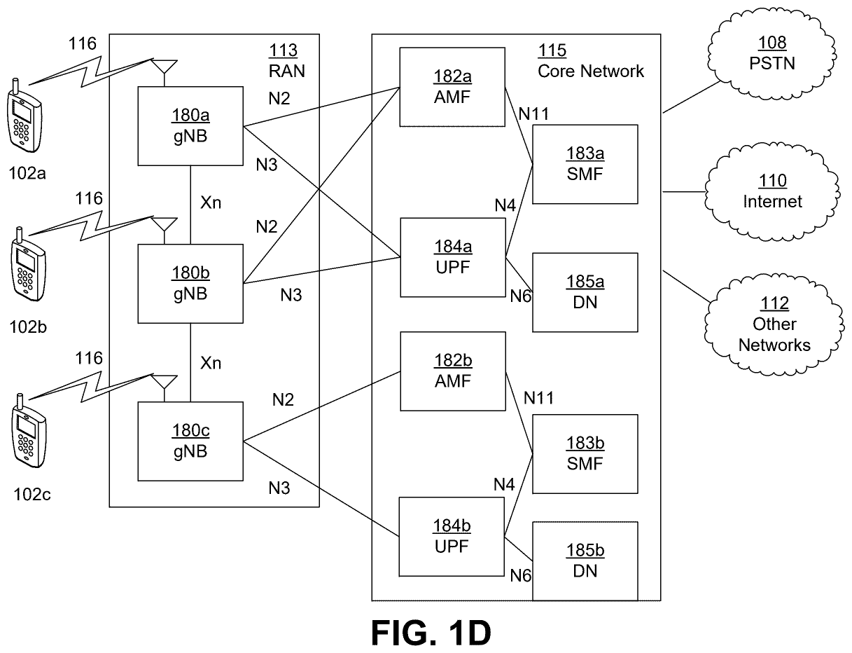

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received (e.g., as indicated by timing information) from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUS 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel.

The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems and methods disclosed herein involve a Data Collection Function (DCF) that facilitates efficient authorization and collection of training data for Artificial Intelligence/Machine Learning (AI/ML) models, thereby allowing such AI/ML models to be trained and deployed efficiently in network environments.

Examples disclosed herein describe various actions that a DCF may perform. Based on a WTRU's capability registration on an AI/ML based analytic service, a DCF may authorize and/or handle a data-collection request from data consumer. In order to fulfill the data-collection request (e.g., satisfy requirements indicated by the data-collection request), the DCF may perform data curation and/or updated data collection.

For instance, a DCF may receive capability registration information for data collection for and/or from WTRUs and/or RAN nodes. The DCF may provide policy and/or configuration information for Protocol Data Unit (PDU) connection setup for WTRU data collection.

Furthermore, a DCF may receive a data-collection-procedure trigger request and/or validate the data-collection-procedure trigger request. The DCF may inform a data consumer that the data-collection-procedure trigger request has been received and/or validated (e.g., by sending the data consumer a message indicating that the data collection procedure has been triggered via the data-collection-procedure trigger request).

In an example, a DCF may receive a data collection request for WTRU data collection. The DCF may authorize the data collection request based on a WTRU's capability (e.g., as indicated by capability information for the WTRU that was received via a capability registration procedure) and other parameters. For instance, to determine whether to authorize the data collection request, the DCF may determine whether the WTRU has capabilities that are sufficient to fulfill the data collection request (e.g., based on the capability information). The DCF may also decide whether to authorize the data collection request based on whether a data consumer that sent the request has sufficient permissions and/or digital credentials to be authorized to make the data collection request. The DCF may request that the WTRU perform WTRU data collection in accordance with the data-collection request (e.g., wherein the data-collection request may have been received from a data consumer). In response, the WTRU and/or a RAN node may perform the WTRU data collection as requested. The WTRU and/or RAN node may send the collected data to the DCF. The DCF may receive the collected data sent from the WTRU and/or RAN node.

After receiving the collected data, the DCF may perform data curation based on requested parameters from the data consumer (e.g., wherein the data-collection request may comprise the requested parameters and the requested parameters may indicate requirements to be satisfied in order to fulfill the data-collection request). The DCF may verify whether the collected data (e.g., the DCF performs curation on the collected data) satisfies one or more requirements indicated by the requested parameters from the data consumer and/or send the result (e.g., a curated set of collected data) to the data consumer.

As used herein, “data collection” refers to a process of collecting data for the purpose of AI/ML model training, performance monitoring, data analytics, and/or inference. The collection of the data may be performed by a WTRU. However, in some cases (e.g., for two-sided models), data collection may also be performed by a network entity (e.g., a Next Generation Node B (gNB) or Location Management Function (LMF), if a two-sided model is used for Channel State Information (CSI) and/or positioning use cases).

Data collected by a WTRU may contain data related to measurements performed by the WTRU (e.g., radio signal level measurements and/or positioning related measurements, etc.).

Data transfer may refer to the sending and/or transferring of collected data from a WTRU to a Data Collection Entity (e.g., a gNB, a Network Function, such as an LMF or a Network Data Analytics Function (NWDAF), an Operations, Administration, and Management (OAM) system or an Over-The-Top (OTT) server, etc.). In some cases, AI/ML model training or AI/ML model performance monitoring may be performed at a server collecting the data. In some cases, a data collection entity (e.g., an entity performing data collection) may be different from an entity doing the model training (e.g., an entity that trains an AI/ML model based on the collected data) or an entity that does AI/ML model performance monitoring.

An “AI/ML model” may refer to a model that results from applying a data-driven algorithm and/or AI/ML techniques to training data such that the model is configured to generate a set of outputs based on a set of inputs.

“AI/ML model inference” may refer to a process of using a trained AI/ML model to produce a set of outputs based on a set of inputs.

A “WTRU-side (AI/ML) model” may refer to an AI/ML model whose inference is performed entirely at a WTRU (e.g., a WTRU-side model may be stored at the WTRU and used at the WTRU to generate sets of outputs based on sets of inputs).

A “network-side (AI/ML) model” may refer to an AI/ML model whose inference is performed entirely at the network (e.g., a gNB, a Network Function, such as the LMF or the NWDAF, the OAM system or an OTT server, etc.).

A “two-sided (AI/ML) model” may refer to a paired AI/ML Model(s) over which joint inference is performed, wherein joint inference may comprise AI/ML inference that is performed jointly across a WTRU and a network (e.g., a first part of inference may be performed by the WTRU and a remaining part of the AI/ML inference may be performed by a gNB, or vice versa).

A WTRU that collects data may or may not support AI/ML related functionalities and/or may not have any AI/ML models stored locally at the WTRU (e.g., the collected data may be used for training of WTRU-side model of other WTRUs, the collected data may be used for the training of a network-side model such as a gNB-side model, etc.).

“Offline model training” may refer to an AI/ML training process wherein an AI/ML model is trained based on a collected dataset, and wherein the trained AI/ML model is later used and/or delivered for inference (e.g., to a WTRU and/or an Al Agent). It should be noted that the training of an AI/ML model may involve the collection of data from multiple WTRUs over a certain period of time and that the collected data may be used for training of WTRU-side models, network-side models, and/or models that are involved in a two-sided model operation (e.g., two-sided models).

An “AI training loop” may be a repetitive process wherein an AI/ML model is iteratively trained (e.g., based on collected data) to minimize a predefined loss function.

The term “ground truth” (GT) may refer to an actual value of a certain measurement or information that is being predicted and/or estimated (e.g., in the case of cell or beam measurements, the ground truth may be the actual signal level of a beam or a cell that is being predicted).

At least two sets of use cases may be considered when considering the possibility of using AI/ML to enhance current RAN procedures.

With AI/ML model inference at a base station (e.g., a gNB), three use cases may be considered to study scenarios in which AI/ML-aided RAN procedures are used and/or in which AI/ML model training (e.g., performed by an AI/ML training entity) is located (e.g., performed) at an OAM system. These use cases may comprise a load balancing use case, a mobility optimization use case, and/or an energy efficiency case. In these use cases, as AI/ML model training is performed at an OAM system, RAN nodes may provide input data to the OAM system. A WTRU may report collected data to the RAN nodes and the RAN nodes may forward the collected data to the OAM system. After AI/ML model training, the OAM system may provide the trained AI/ML model to a RAN node which is responsible for AI/ML model inference.

With AI/ML model inference at a WTRU for WTRU-sided model cases and/or two-sided model cases, three use cases may be considered for positioning, Channel State Information (CSI), and/or beam forming. In these use cases, AI/ML model training may be performed at a network function at an operator system or at an OTT server.

One question to consider is how to support the standardized transfer of standardized data over the User Plane (UP) for WTRU data collection to meet requirements for AI/ML for New Radio (NR) air interface operation with WTRU-side model training. There are many possible requirements for AI/ML for NR.

In an example, requirements for AI/ML for NR may comprise requirements that apply to data transfer of collected data. For instance, a requirement may specify that, when a first terminating point of collected data is a server (e.g., an OTT Server), the AI/ML data transfer path is WTRU->CN->OTT (e.g., WTRU to Core Network (CN) to OTT) and the collected data is transferred over a User Plane Connection to the server. (In this context, a “terminating point” may refer to a specific point in a network where a data flow ends.) A requirement may specify that, when a first terminating point of collected data is an OAM system, the AI/ML data transfer path is WTRU->gNB->OAM->OTT (e.g., WTRU to gNB to OAM to OTT) and the collected data is transferred over a User Plane Connection.

In an example, requirements for AI/ML for NR may comprise requirements that apply to data collection. For instance, a requirement may specify that the collected data is secured and that data integrity and/or confidentiality for that collected data is ensured. Another requirement may specify that user data privacy, anonymity, and/or user consent is respected. A requirement may specify that a Mobile Network Operator (MNO) has full control of a standardized data collection process and can manage data transfer to an OTT server for WTRU-side data collection without requiring a Service Level Agreement (SLA) for this purpose. This may comprise initiating, terminating, and/or fully managing data transfer. A requirement may specify that an MNO has full visibility for standardized data. A requirement may specify that the design (e.g., specified by a standard) is futureproof and/or extendable.

In light of the use cases and/or possible requirements described above, when AI/ML model training is performed at an OTT server, a network function may be involved for data collection from a WTRU as a first terminating point. For this scenario, a user plane connection may be established.

Considering that AI/ML model training may be performed at an application server (e.g., OTT server), for different applications, different application servers may be involved for AI/ML model training with different AI/ML models. This case may occur even though the same analytic information (e.g., location information) may be required by different applications (e.g., as the application server may not be under the control of the operators).

As each application server may train a different respective AI/ML model (e.g., at its own discretion), different kinds of input data and/or training data may be required for different AI/ML models. Collecting data which may satisfy the requirements of every one of these application servers may be a sizable burden for the network and/or a WTRU.

Collecting and providing different kinds of data for groups of WTRUs with high sensitivity and/or a high sampling ratio may be a highly resource-consuming work for the WTRUs and/or mobile operators. In some cases, even though a WTRU may have enough capability to collect data that satisfies the requirements (e.g., different requirements of different application servers), the WTRU may not be able to collect correct data that satisfies these requirements because of constraints in a current environment (e.g., the WTRU may be in a poor cell environment and/or may have a poor energy consumption ratio link). Therefore, it would be advantageous for data collection to be properly handled and negotiated among involved entities before actual operation for data collection happens.

Thus, it would be advantageous to address the question of how a system may efficiently control WTRU data collection when an application function (e.g., among one or more application functions that may require data for AI/ML model training) requests such WTRU data collection.

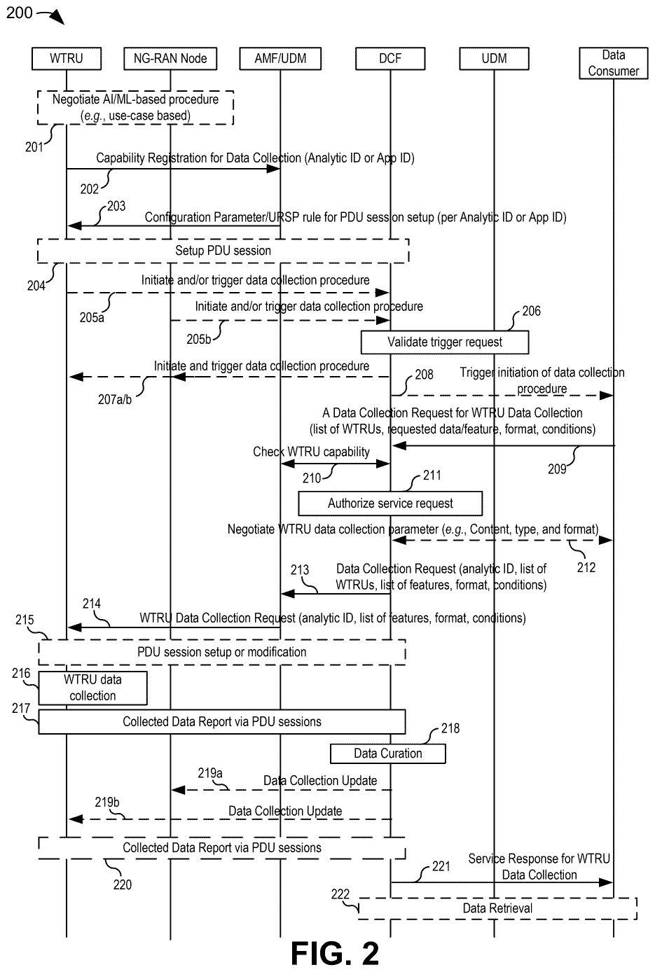

FIG. 2 provides a diagram 200 that depicts a process for WTRU data-collection control by a DCF, according to one example. In other examples, some of the steps depicted in the diagram 200 may be performed in concurrently and/or in orders other than the order shown. Also, in other examples, some of the steps depicted in the diagram 200 may be omitted and/or additional steps not depicted in the diagram 200 may be added. Furthermore, in other examples, entities other than the entities shown in the diagram 200 may perform at least some of the steps depicted in the diagram 200. Furthermore, in other examples, some of the entities shown in the diagram 200 may be co-located within a single entity and/or some of the entities shown in the diagram 200 may represent and/or be replaced by more than one entity. In some examples, one or more actions attributed to a DCF, a RAN, an AMF, an SMF, a PCF, and/or a UDM in the description below may be performed by one or more processors associated with a network device (or, if the one or more actions are performed at other locations within a core network, the network device may serve as an intermediate node and/or relay node that may relay communications between a WTRU and the other locations within the core network). Such a network device (e.g., a base station such as a gNB or another type of network device) may interface with a WTRU via an air interface and may interface with a core network via a backhaul link (e.g., a wired backhaul link and/or an optical backhaul link).

In step 201, depending on a specific RAN procedure being applied (e.g., a specific use case being addressed, such as beam forming, CSI compression, or positioning), the WTRU and a RAN (e.g., via a Next Generation Radio Access Network (NG-RAN) node) may determine whether to use (e.g., apply) a non-AI/ML-based procedure or an AI/ML-based procedure. If an AI/ML-based procedure is to be used, the RAN and the WTRU may determine the data collection requirements to be considered by a data consumer (e.g., by an Over-the-top server responsible for the training of AI/ML models for which these data are to be collected). For instance, the RAN and the WTRU may negotiate the determination of data content, data type (e.g., a list of features), and/or data format (e.g., granularity of collected data, sampling rate, sensitivity, etc.) required for the specific use case(s) and/or RAN procedure(s) for which the collected data are to be used.

Such negotiation may comprise, for example, the WTRU sending a proposal message to the NG-RAN node indicating a proposed list of features (e.g., features associated with the AI/ML models for which data are to be collected for the specific use case(s) and/or RAN procedure(s)) and/or one or more proposed formats (e.g., granularity of collected data, sampling rate, sensitivity, etc.). The WTRU may determine the proposed list of features and/or the one or more proposed formats based on the WTRU's capabilities for data collection (e.g., the WTRU may refrain from including any features that the WTRU does not support in the proposed list and/or refrain from including any formats that the WTRU does not support in the one or more proposed formats). In one example, in response to the proposal message, the NG-RAN node may send an acceptance message that indicates acceptance of the proposed list of features and the one or more proposed formats. In another example, in response to the proposal message, the NG-RAN node may send a counterproposal response message that indicates a first proposed modification to the proposed list of features or the one or more proposed formats. The WTRU may respond by sending an acceptance message indicating acceptance of the first proposed modification or by sending a counterproposal response message that indicates a second proposed modification (e.g., that differs from the first proposed modification). The negotiation may continue until no additional modifications are proposed until both the WTRU and the NG-RAN accept.

For each use case (e.g. beam forming, CSI compression, or positioning), an analytic ID may be assigned and/or managed by the network (e.g., the RAN and/or the NG-RAN node). The WTRU and/or the NG-RAN node may store one or more indications of the capability (e.g., of the WTRU and/or the NG-RAN node) to support data collection per (e.g., for each) analytic ID (e.g., indicating supported data types and/or data formats).

An analytic ID may be configured to (e.g., for) the entities and/or functions (UE, NG-RAN, DCF, NWDAF, data consumer, etc.) that may be involved in the process depicted by the diagram 200. When an analytic service corresponding to an analytic ID is requested and/or handled for a corresponding the use case, the analytic ID may be used to represent the corresponding analytic service among the entities and/or functions.

In step 202, the WTRU may register to (e.g., with) the network (e.g., the RAN). As part of the registering, the WTRU may send the network one or more indications of the WTRU's capabilities for data collection (e.g. Access and Mobility Management Function (AMF), Unified Data management (UDM), etc.). This capability registration for data collection may specify the WTRU's capability for data collection for each analytic ID (e.g., respectively) with a list of features (e.g., requested data type for training an AI/ML model and/or deriving analytics inference result) and/or supported data formats (e.g., granularity of collected data, sampling rate, sensitivity, etc.).

In an example, the NG-RAN node's capabilities for data collection may be registered to (e.g., with) and/or managed in the network (e.g., AMF, DCF). The registered capabilities of the NG-RAN node for data collection (e.g., which may be indicated by one or more indications) may specify the NR-RAN node's capability for data collection for each analytic ID (e.g., respectively) with a list of features (e.g., requested data type for training an AI/ML model and/or deriving analytics inference result) and/or supported data formats (e.g., granularity of collected data, sampling rate, sensitivity, etc.).

In step 203, after the WTRU's capabilities for data collection are authorized (e.g., after the DCF verifies that the WTRU's capabilities for data collection are sufficient to assist in fulfilling the data collection request), the WTRU may be configured with (e.g., receive configuration information indicating) parameters for PDU sessions for data collection (e.g., Data Network Name (DNN)). For different analytic IDs, different PDU sessions may be established (e.g., respectively) based on the configured parameters.

The WTRU may be configured with (e.g., receive configuration information indicating) rules to map an application ID (e.g., associated with the data consumer) to one or more Quality of Service (QOS) flows.

In another example, the WTRU may be configured with (e.g., receive configuration information indicating) rules to map an analytic ID to one or more QoS flows (e.g., server address and/or port number for data collection of each analytic ID, parameters for deriving security credentials for data collection of each analytic ID, etc.).

In another example, the DCF may notify a Policy Control Function (PCF) (not shown) about the data collection triggering (and/or about the registration and/or authorization of the WTRU's data collection capabilities and/or the NG-RAN node's data collection capabilities) and that the PCF may further provision a data collection policy on the WTRU and/or the NG-RAN node that may provide data collection rules. Data collection rules may indicate a list of features (e.g., requested data type for training an AI/ML model and/or deriving analytics inference result) and supported format(s) (e.g., granularity of collected data, sampling rate, sensitivity, etc.), contextual rules (e.g., schedule, location, etc.), and/or DNN and/or QoS flows for reporting the collected data.

In step 204, the WTRU may set up a PDU session for data collection based on the configuration (e.g., configuration information) described above with respect to step 203. Based on the configuration, a dedicated PDU session may be established (e.g., the DNN, and possibly an application ID and/or service identifier) so that a Session Management Function (SMF) may handle traffic for data collection separate from other PDU sessions intended for regular user data (e.g., data for streaming and/or voice services). To facilitate readability and understandability, the SMF is not shown in the diagram 200.

In step 205a, the WTRU may trigger a data collection procedure for a use case. The WTRU may provide an analytic ID (e.g., information indicating a use case), an AI/ML model ID (e.g., information indicating the AI/ML model used for serving an AI/ML based procedure for the use case represented by the analytic ID), a data collection profile identifier, and/or possibly data consumer information (e.g., an OTT ID) that may allow the data consumer to derive (e.g., determine and/or identify) the requirements for the data collection to be satisfied for the use case and/or AI/ML-based procedure.

A data collection profile identifier may represent a data collection profile. The data collection profile may include data type(s) and/or a data format of each data type (e.g., respectively).

In step 205b, the RAN may trigger the data collection procedure. The NG-RAN node may provide an analytic ID, an AI/ML model ID, a data collection profile identifier, and possibly the data consumer information (e.g., OTT id) that may allow the data consumer to derive (e.g., determine and/or identify) the requirements for the data collection to be satisfied for the use case and/or AI/ML-based procedure.

Note that, in some examples, step 205a and step 205b may be alternatives such that either step 205a or step 205b may be performed, but not both.

In step 206, the DCF may validate the trigger initiation request (e.g., based on operator policies and/or subscriber (user) privileges and/or or user consent). In this context, the “trigger initiation request” may refer to a message sent by the WTRU at step 205a and/or a message sent by the NG-RAN node at step 205b.

In step 207a/b, the DCF may acknowledge the data collection initiation request (e.g., the trigger initiation request) by informing the WTRU (e.g., if the trigger initiation request was sent by the WTRU, as in step 205a) and/or the RAN (e.g., if the trigger initiation request was sent by the NG-RAN node, as in step 205b) whether the data collection initiation request (e.g., the trigger initiation request) was granted. If the data collection initiation request (e.g., the trigger initiation request) is denied or partially denied, the DCF may provide information as to why the data collection initiation request (e.g., the trigger initiation request) has been denied (e.g., due to lack of user consent/privileges or the data consumer being unauthorized).

In step 208, if the data collection initiation request was granted, the DCF may send a data collection initiation request (which may match the data collection initiation request that was granted) to the data consumer (e.g., OTT server, application server, etc.) and may provide an analytic ID, an AI/ML model ID, a data collection profile identifier, and/or external identifiers of WTRUs participating in the data collection procedure.

In some examples, the data consumer (e.g., OTT server) may have previously subscribed with the DCF (e.g., via one or more steps not depicted in the diagram 200) and the DCF may notify the data consumer upon receiving the data collection trigger (e.g., the trigger initiation request). The subscription by the data consumer (e.g., with the DCF) may comprise an analytic ID, an AI/ML model ID, a data collection profile identifier, a data consumer identifier (e.g., an application function (AF) identifier), and/or a notification endpoint (e.g., Uniform Resource Locator (URL), Uniform Resource Identifier (URI), Internet Protocol (IP) address, port, etc.) such that the DCF may match the information provided by the WTRU and/or the NG-RAN node in step 205a and/or step 205b to identify the subscribed data consumer and may send a notification and/or a request to the subscribed data consumer about the trigger initiation of the data collection procedure.

In step 209, the data consumer (e.g., OTT server) may send a data collection request for WTRU data collection for one or more WTRU(s). The data collection request may indicate the requested analytic service (e.g., analytic ID), the requested AI/ML model (e.g., AI/ML model ID), and/or the list of features and/or the requested formats of the features for the data collection (e.g., a data collection profile identifier) with validity conditions (e.g., target area, and time). Like the validity conditions, the list of features and/or the requested formats may indicate conditions for selecting WTRUs (e.g., a condition may be that WTRUs have the capability to collect data corresponding to the collected features and/or have the capability to represent collected data in the requested formats). The data collection request may also comprise guidance for User Equipment Route Selection Policy (URSP) rules determination, such as an indication of a Data Network Access Identifier (DNAI) to (e.g., through) which the data consumer (e.g., OTT server) may be accessed. In addition, the data collection request may comprise one or more indications of dataset statistical properties (distribution types and/or parameters, how to handle outliers, etc.) and/or additional conditions for selecting WTRUs (e.g., minimum distance of WTRUs) at the target area. The additional conditions for selecting WTRUs (e.g., conditions for WTRU selection) may be combined with other contextual information (e.g., WTRU location) and WTRU data collection capabilities.

In an example, an additional condition may specify a minimum distance between selected WTRUs. For instance, consider a scenario in which the DCF has identified multiple candidate WTRUs such that each candidate WTRU has sufficient capabilities for data collection to assist in fulfilling the data collection request. For each candidate WTRU, the DCF may decide whether to select the candidate WTRU to perform data collection to fulfill the data collection request in the following manner. If no WTRUs have been selected yet, the DCF may select the candidate WTRU. If one or more WTRUs have already been selected, the DCF may determine whether the candidate WTRU is within a minimum distance of any of the selected WTRUs (e.g., whether each respective distance between the candidate WTRU and a respective selected WTRU is less than a threshold distance). If the candidate WTRU is not within the minimum distance of any of the selected WTRUs, the DCF may select the candidate WTRU. Otherwise, the DCF may exclude the candidate WTRU (e.g., not select the candidate WTRU).

In an example, an additional condition may specify a target area such that WTRUs outside of the target area will not be selected. For instance, the target area may be indicated by a perimeter such that WTRUs located outside of the perimeter will not be selected. May different types of perimeters are possible. For instance, a perimeter may be specified by a geographical point (e.g., specified by Global Positioning System (GPS) coordinates, longitude and latitude, etc.) and a radius such that the perimeter is a circle centered at the geographical point and having the radius may indicate the perimeter.

Step 209 may be triggered as a result of reception of a message (e.g., the data collection initiation request described above with respect to step 208) and/or may be triggered by other events in the data consumer.

In step 210, the system (e.g., the DCF) may check capabilities for data collection of WTRUs included in the received data collection request (e.g., supported list of features, supported formats, etc.).

When conditions for selecting WTRUs are included in the service request (e.g., the data collection request) described with respect to step 209, the system (e.g., the DCF) may select WTRUs that satisfy the conditions for WTRU selection (e.g., the conditions for selecting WTRUs). To determine which WTRUs satisfy the conditions for WTRU selection, the system may request each WTRU's location information from another network function (e.g., Location Management Function (LMF), AMF, Gateway Mobile Location Center (GMLC), etc.).

In step 211, based on the WTRU's capabilities of the WTRUs (or selected WTRUs in step 206), the system (e.g., the DCF) may authorize the data collection request. The DCF (e.g., which may be logically implemented in the Network Exposure Function (NEF), may store the data collection request information in a Unified Data Repository (UDR) (e.g., via the UDM), and may notify (not shown in the diagram 200) the PCF (which the DCF subscribes to data collection requests) that the data collection request has arrived.

The PCF may provide the SMF with Policy and Charging Control (PCC) rules that allow the SMF to select a UPF serving the DNAI to where the data consumer (e.g., OTT server) is located, as well as information for the SMF to configure appropriate URSP rules. In addition, the PCF may determine whether DL data configuration is done over Control Plane (CP) signaling (e.g., using DL Nan-Access Stratum (NAS) TRANSPORT) or over the User Plane (UP) (e.g., using the PDU session the WTRU explicitly set up in step 204 to report the collected data). Based on this configuration, the SMF may provide a user plane connection with proper QoS flows for the PDU session for data collection and configure the selected User Plane Function (UPF). If the data collection request cannot be fulfilled per the WTRU's capabilities indicated via the registration (e.g. some features not supported for data collection, granularity of data collection not supported per WTRU's capabilities), the system (e.g., the DCF) may reject the data collection request and/or the DCF may send a rejection message to the data consumer.

Additionally, after the data collection request (and/or an analytic service associated with the data collection request) is authorized, the DCF may send a response to the data consumer indicating that the data collection request (and/or the associated analytic service) is accepted (e.g., authorized).

In step 212, in an example, the system (e.g., the DCF) may negotiate the parameters for data collection (e.g., the conditions for WTRU selection) with the data consumer (e.g., application server) according to the WTRU's capabilities (e.g., negotiate the list of features for data collection based on common WTRUs' supported feature lists, negotiate the format of data collection for each feature, etc.). As a result of negotiation, the system may down-select WTRUs for data collection based on the data collection request from the data consumer.

The system (e.g., the DCF) may perform the negotiation dynamically by exchanging messages with the data consumer (e.g., OTT server) as shown on the diagram 200. Otherwise, the data consumer may have provided alternative configurations in step 209. The alternative configurations may be considered by the DCF if and/or when the DCF is unable to fulfill requirements. If an alternative configuration is selected by the DCF and the alternative configuration meets the requirements, the DCM may send a notification to the data consumer to indicate which alternative configuration was selected. The negotiation between the system (e.g., the DCF) and the data consumer may comprise, for example, exchanging one or more proposal messages, counterproposal response messages, and/or acceptance messages (e.g., similar to those described above with respect to step 201) between the system and the data consumer.

In step 213, the system (e.g., the DCF) may send WTRU data collection requests to the WTRU(s) (or selected WTRU(s) based on the data collection request received from the data consumer (e.g., application server). The WTRU data collection request may include an analytic ID, a list of WTRUs, a list of features, a format, and/or conditions. Based on the parameter negotiation of step 212, the updated list of features and/or format(s) may be included. The WTRU data collection request may be sent through the CP via the AMF (e.g., using a DL NAS TRANSPORT message) or using the PDU Session connected for the data collection as configured. As another example, the SMF may send a PDU session modification request to include the WTRU data collection request as Protocol Configuration Option (PCO) parameters.

In step 214, the WTRU data collection request may be sent to each WTRU (e.g., as a signaling message) via the WTRU's serving AMF if the data collection message is sent through control plane.

In step 215, after receiving the WTRU data collection request, the WTRU may set up a PDU session and/or modify an existing PDU session for data collection. The SMF may control the PDU session modification request and/or the PDU session establishment request based on configured information (e.g., such as the types of information discussed above with respect to step 211).

In step 216, as requested, the WTRU may perform the data collection procedure (e.g., as allowed by the MNO) to collect data corresponding to the requested features and store the collected data in the requested format(s) for data collection.

In step 217, the WTRU may send the collected data (e.g., via the PDU session) to the system (e.g., the DCF). Along with the collected data, the WTRU may send additional contextual information to identify the collected data (e.g., WTRU info, requested analytic service ID, feature information, etc.) and/or to indicate conditions under which the data was collected (e.g., time period, area, measurement conditions such as resolution of collected data, etc.).

As another example, the WTRU may send the additional contextual information separately to the system (e.g., via a signaling message at the control plane).

In step 218, after receiving the collected data, the system (e.g., the DCF) may curate the collected data to satisfy the requested dataset statistical properties described above with respect to step 209 (e.g., removing and/or modifying outliers, verifying whether the collected data from the WTRU(s) satisfies the statistical properties, aligning data format of the collected data, etc.), thereby resulting in (e.g., forming) a curated set of collected data.

In an example, “aligning the data format of the collected data” may refer to performing one or more actions to ensure that the collected data (e.g., comprising data collected by different WTRUs and/or RAN nodes) is represented in a same format. For instance, if some WTRUs represent collected data using 64-bit quantization and other WTRUs represent collected data using 32-bit quantization, the system (e.g., the DCF) may convert collected data that was represented using the 64-bit quantization format to the 32-bit quantization format.

The system (e.g., the DCF) may adjust the selected list of WTRUs (e.g., a list of the WTRUs selected in step 210 that satisfy the conditions for WTRU selection) to ensure that the collected data from them satisfies the statistical properties while also satisfying a minimum number of samples.

The system (e.g., the DCF) may discard some of WTRUs from the list of samples if the system determines that the data collected by those WTRUs is redundant for AI/ML model training.

In an example, to determine whether collected data is redundant, the system (e.g., the DCF) may determine whether a first set of data collected by a first WTRU and a second set of data collected by a second WTRU are located at a same location within a distribution of the collected data (e.g., a distribution over one or more variables such as time of data collection, geographical location where data collection occurred, values of the types of collected data, and/or values of the features). If the first set of data and the second set of data are both located at the same location in the distribution, the DCF may conclude that the second set of data is redundant and may remove the second set of data from the collected data.

In some examples, the data consumer (e.g., OTT server) may provide performance indicators to the DCF. The performance indicators may be related to the data collection session for AI/ML model training. For example, the data consumer may determine that insufficient data has been collected (e.g., to train the AI/ML model in a timely manner) and may indicate to the DCF that more WTRUs will have to be added to the data collection (DC) session. The DCF may add WTRUs to the data collection session accordingly. For example, the data consumer may determine that many samples were received for a first area of interest and too few samples were received for a second area of interest. Therefore, the data consumer may indicate to the DCF to reduce the number of WTRUs for the first area of interest and increase the number of WTRUs for the second area of interest in the data collection session. The data consumer may also provide other performance indicators and/or criteria related to AI/ML model training (e.g., accuracy, convergence, generalization, statistical, robustness, etc.). Based on the other performance indicators and/or criteria, the DCF may reconsider and/or update the configuration of the data collection session (e.g., number of WTRUs, location(s) of WTRUs, and/or data collection characteristics).

In step 219a and/or step 219b, if the collected data does not satisfy the requirements (e.g., the requirements for the data collection to be satisfied for the use case and/or AI/ML-based procedure as described above with respect to step 205a and step 205b), the system (e.g., the DCF) may trigger WTRU data collection updates for additional WTRUs and/or collection of different data for satisfying the requirements (e.g., by sending a second data collection request). Additionally or alternatively, the system (e.g., the DCF) may send a second data collection request to the RAN nodes (e.g., the NG-RAN node) for different data for satisfying the requirements.

In step 220, based on the second data collection request described above with respect to step 219a or step 219b, additional and/or different data may be collected by the WTRU(s) and/or RAN node(s).

In step 221, after data curation, the system (e.g., the DCF) may send a service response for WTRU data collection to the data consumer.

In other example, the system (e.g., the DCF) may store the collected data at a different server (e.g., data repository server).

The service response to the data consumer may comprise collected data and/or information indicating how to retrieve the collected data. (e.g., an address of a data repository server).

In the service response, in addition to the collected data, additional contextual information may be added to indicate a time period in which the data was collected, an area in which the data was collected, and/or measurement conditions (e.g., resolution of collected data, etc.) under which the data was collected.

In step 222, based on the service response, the data consumer may retrieve the collected data (e.g., from a data repository server).

In some examples, systems may dynamically train AI/ML models and/or may dynamically curate the collected data (e.g., to form a curated set of collected data). The service response sent in step 221 may be a notification to the data consumer about dynamic changes in the data collection configuration.

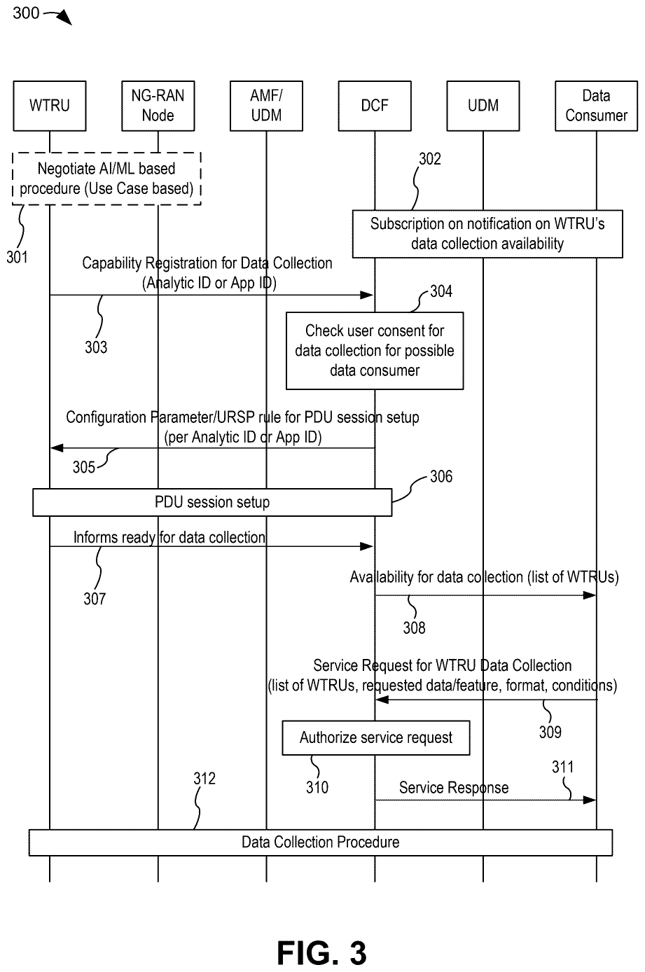

FIG. 3 provides a diagram 300 that depicts another process for WTRU data-collection control by a DCF, according to one example. In other examples, some of the steps depicted in the diagram 300 may be performed in concurrently and/or in orders other than the order shown. Also, in other examples, some of the steps depicted in the diagram 300 may be omitted and/or additional steps not depicted in the diagram 300 may be added. Furthermore, in other examples, entities other than the entities shown in the diagram 300 may perform at least some of the steps depicted in the diagram 300. Furthermore, in other examples, some of the entities shown in the diagram 300 may be co-located within a single entity and/or some of the entities shown in the diagram 300 may represent and/or be replaced by more than one entity. In some examples, one or more actions attributed to a DCF, a RAN, an AMF, an SMF, a PCF, and/or a UDM in the description below may be performed by a one or more processors associated with a network device (or, if the one or more actions are performed at other locations within a core network, the network device may serve as an intermediate node and/or relay node that may relay communications between a WTRU and the other locations within the core network). Such a network device (e.g., a base station such as a gNB or another type of network device) may interface with a WTRU via an air interface and may interface with a core network via a backhaul link (e.g., a wired backhaul link and/or an optical backhaul link).

In step 301, the WTRU and/or the NG-RAN node may perform the actions described above with respect to step 201 of FIG. 2.

In step 302, the data consumer may send a subscription request to subscribe to a notification service of the DCF on the WTRU's data collection availability (e.g., the notification service may be configured to provide notifications of data collection availability of WTRUs to subscribers). The subscription request may indicate a requested analytic ID, a requested AI/ML model ID, and/or a requested list of WTRUS.

In step 303, the WTRU may register to (e.g., with) the DCF. As part of the registering, the WTRU may send the DCF an indication of the WTRU's capabilities for data collection. The capability registration for data collection may indicate the WTRU's capabilities for data collection for each analytic ID with a list of features (e.g., requested data type(s) for training AI/ML model and/or deriving analytics inference result) and supported data format(s) (e.g., granularity of collected data, sampling rate, sensitivity, etc.).

In an example, the NG-RAN node's capabilities for data collection may be registered to (e.g., with) and/or managed in the network (e.g., AMF, DCF). The registered capabilities of the NG-RAN node for data collection (e.g., which may be indicated by one or more indications) may specify the NR-RAN node's capability for data collection for each analytic ID (e.g., respectively) with a list of features (e.g., requested data type for training an AI/ML model and/or deriving analytics inference result) and/or supported data formats (e.g., granularity of collected data, sampling rate, sensitivity, etc.).

In step 304, the DCF may verify whether the WTRU has consent on (e.g., for) the data collection for (e.g., on behalf of) the possible data consumer (e.g., the data consumer that subscribed at the notification service at step 302 and/or an application associated with the data consumer).

In step 305, after the WTRU's capabilities for data collection are authorized (e.g., after the DCF verifies that the WTRU's capabilities for data collection are sufficient to assist in fulfilling the data collection request), the WTRU may be configured with (e.g., receive configuration information indicating) parameters for PDU sessions for data collection (e.g., DNN). For different analytic IDs, different PDU sessions may be established (e.g., respectively) based on the configured parameters.

The WTRU may be configured with (e.g., receive configuration information indicating) rules to map an application ID (e.g., of an application authorized by user consent to be a data consumer) to one or more QOS flows.

In another embodiment, the WTRU may be configured with rules to map an analytic ID to one or more QoS flows. (e.g., server address and/or port number for data collection of each analytic ID, parameters for deriving security credentials for data collection of each analytic ID, etc.).

In another example, the DCF may notify a Policy Control Function (PCF) (not shown) about the data collection triggering (and/or about the registration and/or authorization of the WTRU's data collection capabilities and/or the NG-RAN node's data collection capabilities) and that the PCF may further provision a data collection policy on the WTRU and/or the NG-RAN node that may provide data collection rules. Data collection rules may indicate a list of features (e.g., requested data type for training an AI/ML model and/or deriving analytics inference result) and supported format(s) (e.g., granularity of collected data, sampling rate, sensitivity, etc.), contextual rules (e.g., schedule, location, etc.), and/or DNN and/or QoS flows for reporting the collected data.

In step 306, the WTRU may set up a PDU session for data collection based on the configuration (e.g., configuration information) described above with respect to step 305. Based on the configuration, a dedicated PDU session may be established (e.g., the DNN, and possibly an application ID and/or service identifier) so that an SMF may handle traffic for data collection separate from other PDU sessions intended for regular user data (e.g., data for streaming and/or voice services). To facilitate readability and understandability, the SMF is not shown in the diagram 300.

In step 307, after successful setup of a PDU session for data collection (e.g., as described above with respect to step 306), the WTRU may inform the DCF (e.g., by sending a message to the DCF indicating) that the WTRU is ready for data collection (e.g., indicating that the PDU session for data collection is available).

In step 308, based on received capability information (e.g., as described above with respect to step 303) and verification of user consent for data collection for the data consumer from WTRUs (e.g., as described above with respect to step 304), the DCF may provide (e.g., send) a notification (e.g., of data collection availability of WTRUs) when WTRUs which are indicated by (e.g., listed in) the subscription request described above with respect to step 302 are available for data collection for the analytic ID (if requested) and/or for the requested AI/ML model ID (if requested).

In addition and/or alternatively, when the subscription request described above with respect to step 302 indicates a requested analytic ID and/or a requested AI/ML model ID, the DCF may provide a list of WTRUs supporting the requested analytic ID and/or the requested AI/ML model ID. The number of WTRUS included on the list may be based on a pre-configuration (e.g., indicated via configuration information), based on information in the subscription request described above with respect to step 302, and/or based on implementation.

In step 309, the data consumer may send a data collection request for WTRU data collection (e.g., comprising data collection request information) to the DCF (e.g., as specified above with respect to step 209 of FIG. 2).

In step 310, based on the registered WTRU's (and/or RAN node's) capabilities as indicated to the DCF in step 303, the DCF may authorize the data collection request. The DCF (e.g., which may be logically implemented in an NEF) may store the data collection request information in a UDR (e.g., via a UDM) and (not shown on the figure) and may notify (not shown in the diagram 300) the PCF (which the DCF subscribes to data collection requests) that the data collection request has arrived.

The PCF may provide the SMF with PCC rules that allow the SMF to select a UPF serving the DNAI to where the data consumer (e.g., OTT server) is located, as well as information for the SMF to configure appropriate URSP rules. In addition, the PCF may determine whether DL data configuration is done over CP signaling (e.g., using DL Nan-Access Stratum (NAS) TRANSPORT) or over the User Plane (UP) (e.g., using the PDU session the WTRU explicitly set up in step 306 to report the collected data). Based on this configuration, the SMF may provide a user plane connection with proper QoS flows for the PDU session for data collection and configure the selected UPF).

In some examples, the DCF may perform parameter negotiation with the data consumer (e.g., as described above with respect to step 212 of FIG. 2).

In step 311, after the data collection request is authorized, the DCF may send a response to the data consumer indicating that the data collection request is accepted (e.g., authorized). If the data collection request cannot be fulfilled per the WTRU's capabilities indicated via the registration (e.g. some features not supported for data collection, granularity of data collection not supported per WTRU's capabilities), the DCF may reject the data collection request and/or the DCF may send a rejection message to the data consumer.

In step 312, the DCF may send WTRU data collection requests to the selected WTRUs (e.g., WTRUs which are indicated by the subscription request and/or WTRUs in the list of WTRUs supporting the requested analytic ID and/or the requested AI/ML model ID, as described above with respect to step 302) and/or perform the data collection procedures among the DCF, the WTRU(s), and/or the NG-RAN node(s) as described above with respect to steps 213-220 of FIG. 2. After successful data collection, the DCF may send a response to the data consumer (e.g., as described above with respect to step 222 of FIG. 2).

In an example, based on a notification from a DCF, a data consumer may retrieve collected data (e.g., data collected by WTRUs and/or NG-RAN nodes) for AI/ML model training.

While performing AI/ML model training, the data consumer may update a data collection request (e.g., and send the updated data collection request to the DCF). Based on the updated data collection request, the DCF may request additional data collection (e.g., from WTRUs and/or NG-RAN nodes).

After collecting the additional data and/or combining (e.g., consolidating) the additional data with existing (e.g., previously collected) data, the DCF may perform data curation.

The data curation may include verifying statistical characteristics of the collected data (e.g., comprising both the previously collected data and the additional data). The data curation (e.g., performed by the DCF) may comprise handling outliers (e.g., deleting and/or modifying outliers) and/or removing some redundant data.

After performing the data curation, the DCF may notify the data consumer of, and/or send the updated data (e.g., the collected data comprising both the previously collected data and the additional data after curation) to, the data consumer.

In an example, a data consumer (e.g., an application server), a network (e.g., a 5G NW), and/or a WTRU may be preconfigured with (e.g., receive configuration information beforehand indicating) a supported data format for an analytic service and/or a respective supported data format for each feature for an analytic service.

When a service request is received from the data consumer (e.g., application server), the service request may comprise a requested data format ID for the requested analytic service and/or for each feature for an analytic service.

Based on the data format ID for each analytic service and/or based on a feature list and a respective associated data format ID for each feature (e.g., each feature included in the feature list) for an analytic service, the system (e.g., the DCF) may verify the supported capabilities of the WTRU for the requested analytic service.

There may be a different configuration list of features and/or associated data format for each analytic service, respectively. The WTRU may support multiple configurations which may be represented by (e.g., indicated by) configuration ID(s).

If there are multiple possible configurations, the data consumer (e.g., application server) may include the configuration ID for the requested data collection for each analytic service (e.g., respectively) in the service request. Based on the configurations supported by WTRUs (e.g., as indicated by WTRU capabilities provided by WTRUs during registration) and the configuration IDs thereof, the system (e.g., the DCF) may authorize the service request.

If the WTRUs may support multiple configurations, a commonly supported configuration may be selected for data collection for the analytic service.

If there is a configuration ID selected for data collection (e.g., indicated via the service request), the WTRU may perform data collection for the features and represent the collected data in associated data format for the configuration ID.

The system (e.g., the DCF) may verify whether the collected data satisfies (e.g., matches and/or conforms to) the features and/or associated data format for the configuration ID.

1. A network device comprising:
one or more processors configured to:
receive a first data collection request from a data consumer, wherein the first data collection request indicates at least one condition for wireless transmit/receive unit (WTRU) selection for data collection for the data consumer;
identify a plurality of WTRUs that satisfy the at least one condition for WTRU selection based on WTRU capability information associated with the plurality of WTRUs;
send a plurality of second data collection requests to the plurality of WTRUs based on the first data collection request;
receive, from the plurality of WTRUs, data collected by the WTRUs responsive to the plurality of second data collection requests;
curate the data collected by the WTRUs based on the first data collection request to form a curated set of collected data; and
send the curated set of collected data to the data consumer.

2. The network device of claim 1, wherein the one or more processors are further configured to:
receive the WTRU capability information from the plurality of WTRUs, wherein the WTRU capability information indicates, for each WTRU of the plurality of WTRUs:
a list of features the WTRU supports; or
an indication of one or more data formats the WTRU supports.

3. The network device of claim 1, wherein the first data collection request comprises:
an analytic ID that indicates an analytic service for which the data consumer requests data collection;
an AI/ML model ID that indicates an AI/ML model to be trained via the data collected by the WTRUs;
a list of features for data collection, wherein the features are associated with the AI/ML model; or an indication of one or more requested formats of the features.

4. The network device of claim 3, wherein the at least one condition for WTRU selection is based on one or more of: the list of features for data collection or the one or more requested formats of the features.

5. The network device of claim 1, wherein the at least one condition is indicated by one or more parameters for data collection, and wherein the one or more processors are configured to:
negotiate the one or more the parameters for data collection with the data consumer based on the WTRU capability information.

6. The network device of claim 5, wherein the first data collection request comprises a list of parameters for data collection, and wherein the one or more processors are configured to:
generate an updated list of features for data collection based on the negotiation of the one or more parameters for data collection, wherein each of the second data collection requests comprises the updated list of features for data collection.

7. The network device of claim 1, wherein first data collection request indicates one or more statistical properties to be satisfied via the data collected by the WTRUs.

8. The network device of claim 7, wherein the one or more processors being configured to curate the data collected by the WTRUs based on the first data collection request to form a curated set of collected data comprises the one or more processors being configured to:
delete one or more outliers from the data collected by the WTRUs;
remove redundant data from the data collected by the WTRUs;
verify that the data collected by the WTRUs satisfies the one or more statistical properties; or
align a data format of the collected data with a data format indicated by the first data collection request.

9. The network device of claim 1, wherein the one or more processors are further configured to:
generate a list that indicates the plurality of WTRUs;
determine, based on the data collected by the WTRUs, that at least one WTRU indicated by the list failed to satisfy the at least one condition for WTRU selection; and
adjust the list to remove the at least one WTRU therefrom.

10. The network device of claim 1, wherein the one or more processors are further configured to, prior to reception of the first data collection request:
receive a first data collection initiation request from a WTRU of the plurality of WTRUs;
validate the first data collection initiation request based on one or more of: an operator policy, user privileges associated with the WTRU, or user consent associated with the WTRU); and
send a second data collection initiation request to the data consumer based on the validation of the first data collection initiation request.

11. The network device of claim 1, wherein the one or more processors are further configured to, prior to reception of the first data collection request:
receive a first data collection initiation request from a second RAN node;
validate the first data collection initiation request; and
send a second data collection initiation request to the data consumer based on the validation of the first data collection initiation request.

12. The network device of claim 1, wherein the first data collection request comprises an indication of a Data Network Access Identifier (DNAI) through which the data consumer (may be accessed.

13. The network device of claim 1, wherein the first data collection request indicates a minimum distance between WTRUs, and wherein the at least one condition for WTRU selection is based on the minimum distance.

14. The network device of claim 1, wherein the one or more processors are further configured to, prior to sending the plurality of second data collection requests to the plurality of WTRUs based on the first data collection request:
authorize the first data collection request based on the WTRU capability information associated with the plurality of WTRUS.

15. A method performed by a network device, the method comprising:
receiving a first data collection request from a data consumer, wherein the first data collection request indicates at least one condition for wireless transmit/receive unit (WTRU) selection for data collection for the data consumer;
identifying a plurality of WTRUs that satisfy the at least one condition for WTRU selection based on WTRU capability information associated with the plurality of WTRUs;
sending a plurality of second data collection requests to the plurality of WTRUs based on the first data collection request;
receiving, from the plurality of WTRUs, data collected by the WTRUs responsive to the plurality of second data collection requests;
curating the data collected by the WTRUs based on the first data collection request to form a curated set of collected data; and
sending the curated set of collected data to the data consumer.

16. The method of claim 15, further comprising:
receive the WTRU capability information from the plurality of WTRUs, wherein the WTRU capability information indicates, for each WTRU of the plurality of WTRUs:
a list of features the WTRU supports; or
an indication of one or more data formats the WTRU supports.

17. The method of claim 15, wherein the first data collection request comprises:
an analytic ID that indicates an analytic service for which the data consumer requests data collection;
an AI/ML model ID that indicates an AI/ML model to be trained via the data collected by the WTRUs;
a list of features for data collection, wherein the features are associated with the AI/ML model; or an indication of one or more requested formats of the features.

18. The method of claim 17, wherein the at least one condition for WTRU selection is based on one or more of: the list of features for data collection or the one or more requested formats of the features.

19. The method of claim 15, wherein the at least one condition is indicated by one or more parameters for data collection, and wherein the method further comprises:
negotiating the one or more the parameters for data collection with the data consumer based on the WTRU capability information.

20. The network device of claim 19, wherein the first data collection request comprises a list of parameters for data collection, and wherein the method further comprises:
generating an updated list of features for data collection based on the negotiation of the one or more parameters for data collection, wherein each of the second data collection requests comprises the updated list of features for data collection.
